(19) United States
(12) Patent Application Publication
(10) Pub. No.: US 2023/0084216 A1
(43) Pub. Date: Mar. 16, 2023

(54) CRIME INVESTIGATION ASSISTING SYSTEM, CRIME INVESTIGATION ASSISTING DEVICE, CRIME INVESTIGATION ASSISTING METHOD, AND RECORDING MEDIUM IN WHICH CRIME INVESTIGATION ASSISTING PROGRAM IS STORED

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 17/909,083

(22) PCT Filed: Mar. 30, 2020
(86) PCT No.: PCT/JP2020/014432

§ 371 Date: Sep. 2, 2022

(51) Int. Cl. G06Q 50/26

(52) U.S. Cl. CPC G06Q 50/26

(57) ABSTRACT

A crime investigation assisting system 30 is provided with an estimation unit 32 for estimating the type of a second case on the basis of: an estimation model 31 representing a relationship between action history information 300 (representing a time-series change of action of related persons) and human relation information 303 (representing a time-series change of human relation of related persons) pertaining to a first case and a type 314 of the first case; and action history information 300 and human relation information 303 pertaining to the second case.

### TECHNICAL FIELD

The present invention relates to a crime investigation assisting system, a crime investigation assisting device, a crime investigation assisting method, and a recording medium storing a crime investigation assisting program.

### BACKGROUND ART

It is important to predict occurrence of a criminal case (also referred to as a case or a criminal offense) in advance and prevent the occurrence in advance in order to construct a safe society.

PTL 1 discloses a system that predicts an occurrence place and time of a crime in real time by template matching.

### CITATION LIST

### Patent Literature

[PTL 1] JP 2016-166938 A

### Non Patent Literature

[NPL 1] Lu Wang, Wenchao Yu, Wei Wang, Wei Cheng, Wei Zhang, Hongyuan Zha, Xiaofeng He, Haifeng Chen, “Learning Robust Representations with Graph Denoising Policy Network”, arXiv:1910.01784, Oct. 4, 2019

[NPL 2] Dongkuan Xu, Wei Cheng, Dongsheng Luo, Xiao Liu, Xiang Zhang, “Spatio-Temporal Attentive RNN for Node Classification in Temporal Attributed Graphs”, Twenty-Eighth International Joint Conference on Artificial Intelligence Main track, Pages 3947-3953, Aug. 11-12, 2019

[NPL 3] Wenchao Yu, Wei Cheng, Charu Aggarwal, Kai Zhang, Haifeng Chen, Wei Wang, “ NetWalk: A Flexible Deep Embedding Approach for Anomaly Detection in Dynamic Networks”, KDD 2018, Aug. 19-23, 2018, London, United Kingdom

### SUMMARY OF INVENTION

### Technical Problem

PTL 1 can prevent the occurrence of a criminal case by predicting the occurrence of a criminal case that has not occurred yet. However, usually, an investigation after occurrence of a criminal case is manually performed by a police investigator. Specifically, an investigation is often performed by relying on experience and intuition of a skilled police investigator.

A main object of the present invention is to provide a crime investigation assisting system and the like that suitably assists investigation of a criminal case in such a way that the case can be solved without depending on experience and intuition of a skilled police investigator.

### Solution to Problem

A crime investigation assisting system according to an aspect of the present invention includes an estimation means configured to estimate, based on an estimation model representing a relationship between action history information and personal relationship information about a first case and a type of the first case, and the action history information and the personal relationship information about a second case, a type of the second case, wherein the action history information represents a time-series change in action of a person concerned in the first case or the second case, and the personal relationship information represents a time-series change in personal relationship of the person concerned in the first case or the second case.

In another viewpoint of achieving the above object, a crime investigation assisting method according to an aspect of the present invention includes, by an information processing system, estimating, based on an estimation model representing a relationship between action history information and personal relationship information about a first case and a type of the first case, and the action history information and the personal relationship information about a second case, a type of the second case, wherein the action history information represents a time-series change in action of a person concerned in the first case or the second case, and the personal relationship information represents a time-series change in personal relationship of the person concerned in the first case or the second case.

In still another viewpoint of achieving the above object, a crime investigation assisting program according to an aspect of the present invention causes a computer to execute an estimation process of estimating, based on an estimation model representing a relationship between action history information and personal relationship information about a first case and a type of the first case, and the action history information and the personal relationship information about a second case, a type of the second case, wherein the action history information represents a time-series change in action of a person concerned in the first case or the second case, and the personal relationship information represents a time-series change in personal relationship of the person concerned in the first case or the second case.

Furthermore, the present invention can also be achieved by a computer-readable nonvolatile recording medium storing the crime investigation assisting program (computer program).

### Advantageous Effects of Invention

According to the present invention, it is possible to obtain a crime investigation assisting system and the like that can suitably assist an investigation in such a way that a criminal case can be resolved even by a non-skilled police investigator.

### BRIEF DESCRIPTION OF DRAWINGS

FIG. 1 is a block diagram illustrating a configuration of a crime investigation assisting system 10 according to a first example embodiment of the present invention.

FIG. 2 is a diagram illustrating contents of movement history information 101 according to the first example embodiment of the present invention.

FIG. 3 is a diagram illustrating contents of communication history information 102 according to the first example embodiment of the present invention.

FIG. 4 is a diagram illustrating contents of personal relationship information 103 according to the first example embodiment of the present invention.

FIG. 5 is a diagram illustrating a configuration of a graph 120 according to the first example embodiment of the present invention.

FIG. 6 is a diagram illustrating a procedure in which a graph generation unit 12 according to the first example embodiment of the present invention generates the graph 120 used as teacher data when a model generation unit 13 generates an estimation model 130.

FIG. 7 is a flowchart illustrating an operation (processing) in which the crime investigation assisting system 10 according to the first example embodiment of the present invention generates an estimation model 130 (performs machine learning).

FIG. 8 is a diagram illustrating a mode in which a display control unit 15 according to the first example embodiment of the present invention displays an estimation result on a display screen 200.

FIG. 9 is a flowchart illustrating an operation in which the crime investigation assisting system 10 according to the first example embodiment of the present invention estimates the type of a case.

FIG. 10 is a block diagram illustrating a configuration of a crime investigation assisting system 30 according to a second example embodiment of the present invention.

FIG. 11 is a block diagram illustrating a configuration of an information processing system 900 capable of achieving the crime investigation assisting system 10 according to the first example embodiment or the crime investigation assisting system 30 according to the second example embodiment of the present invention.

### EXAMPLE EMBODIMENT

A system exemplifying an example embodiment to be described later uses a learned model (also referred to as an estimation model) generated by machine learning (for example, deep learning) when estimating a target event from certain input information. Then, the system uses, for example, a graph including a node and an edge (also referred to as a branch) representing the input information. The graph changes in structure over time. The idea of the system has come when applying an algorithm capable of analyzing features of such a graph. As this algorithm, for example, the following algorithms are known.

### (1) TGFN(Temporal Graph Factorization Network)

It is an algorithm that extracts a static feature that is unchanged regardless of time and a dynamic feature unique to each time from a graph whose structure changes with the lapse of time, and analyzes the extracted feature. Since this algorithm is disclosed in NPL 1, the detailed description thereof will be omitted in the example embodiment described later.

### (2) STAR (Spatio-Temporal Attentive RNN)

It is an algorithm for identifying and analyzing, from a graph whose structure changes with the lapse of time, a node that is important (that is, the degree of influence on estimation is high.) on estimation of a certain event, for example, on each of a time axis and a spatial axis among nodes constituting the graph. Since this algorithm is disclosed in NPL 2, the detailed description thereof will be omitted in the example embodiment described later.

### (3) Netwalk

It is an algorithm for extracting a feature amount of a node constituting a graph from the graph whose structure changes with time. Since this algorithm is disclosed in NPL 3, the detailed description thereof will be omitted in the example embodiment described later.

The disclosure exemplifying the example embodiment to be described later achieves improvement in accuracy with which a target event is estimated by applying the above-described algorithm when generating a learned model and when estimating the target event from certain input information using the learned model.

Hereinafter, embodiments of the present invention will be described in detail with reference to the drawings.

### First Example Embodiment

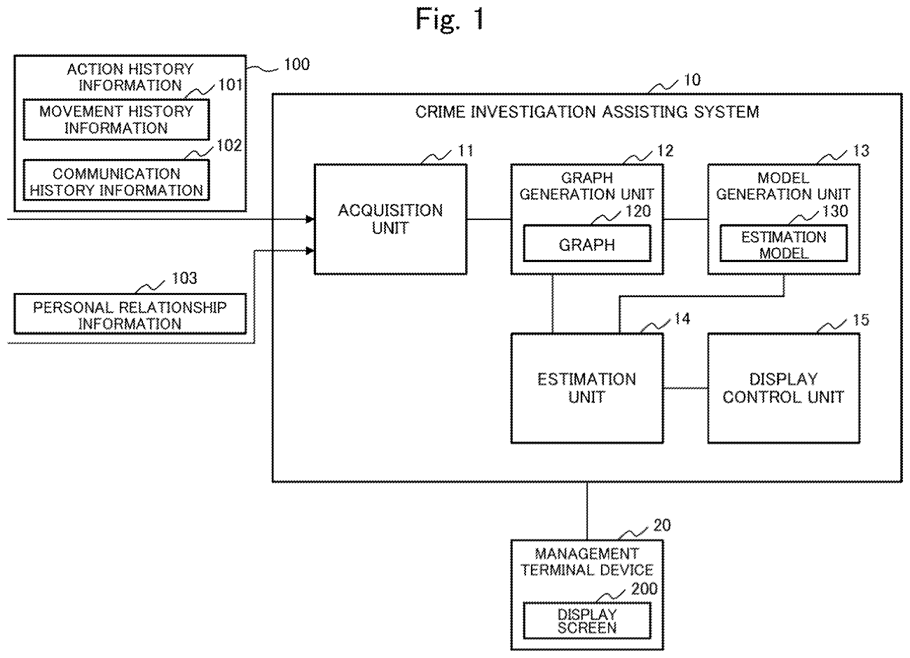

FIG. 1 is a block diagram illustrating a configuration of a crime investigation assisting system 10 according to a first embodiment of the present invention. The crime investigation assisting system 10 is a system that assists an investigation by classifying types of criminal cases. Specifically, the crime investigation assisting system 10 according to the present example embodiment is a system that estimates the type of the case based on information about the action history and the personal relationship of a person concerned in the case under investigation.

The type of a case is, for example, in the case of a missing case, an abduction case, a runaway case, an accident, or the like. In addition, the type of a case is, for example, in the case of a homicide case, a grudging case, a burglary case, a passerby (indiscriminate) case, an injury causing death case, and the like. In addition, the type of a case is, for example, in the case of a theft case, burglary, shoplifting, intrusion theft, automobile theft, snatching, pickpocketing, and the like. In addition, for example, in the case of an economic case, the type of a case includes fraud, embezzlement, bribery, bid-rigging, counterfeiting, bribery, violation of the law on intercession for gain, breach of duty, violation of the antitrust law, intellectual property right infringement, violation of the Unfair Competition Prevention Law, tax evasion, violation of the Securities and Exchange Act such as insider trading, and the like.

The type of the case may be a more finely classified type. The type of a case may be a type having a large granularity, such as a missing case, a homicide case, an assault case, a theft case, and an economic case.

For one or more cases that have already been resolved, the crime investigation assisting system 10 generates a learned model (also referred to as an estimation model) by using information about an action history and a personal relationship of a person concerned in the case in which the type of the case is assigned as a label. Then, the crime investigation assisting system 10 estimates a type of the case under investigation using the learned model. The crime investigation assisting system 10 includes at least one or more information processing apparatuses.

A management terminal device 20 (also referred to as a display device) is communicably connected to the crime investigation assisting system 10. The management terminal device 20 is, for example, a personal computer or another information processing apparatus used when a user who uses the crime investigation assisting system 10 inputs information to the crime investigation assisting system 10 or confirms information output from the crime investigation assisting system 10. The management terminal device 20 includes a display screen 200 that displays information output from the crime investigation assisting system 10.

The crime investigation assisting system 10 includes an acquisition unit 11, a graph generation unit 12, a model generation unit 13, an estimation unit 14, and a display control unit 15. The graph generation unit 12, the model generation unit 13, the estimation unit 14, and the display control unit 15 are examples of a graph generation means, a model generation means, an estimation means, and a display control means, respectively.

Next, an operation in which the crime investigation assisting system 10 according to the present example embodiment generates or updates (relearns) an estimation model 130 for estimating a type of the case under investigation and an operation in which a type of the case is estimated using the estimation model 130 will be described.

<Operation of Generating (and Updating or Re-Learning) Estimation Model 130>

First, an operation in which the crime investigation assisting system 10 according to the present example embodiment acquires information for investigation, and then generates or updates the estimation model 130 for estimating a type of the case under investigation by will be described.

The acquisition unit 11 acquires the action history information 100 and the personal relationship information 103 regarding a case to be learned (also referred to as a first case) from a computer device (not illustrated) or a database via a network. For example, the acquisition unit 11 may periodically acquire the action history information 100 and the personal relationship information 103. Alternatively, for example, the acquisition unit 11 may acquire the action history information 100 and the personal relationship information 103 according to an instruction input by the user via the management terminal device 20.

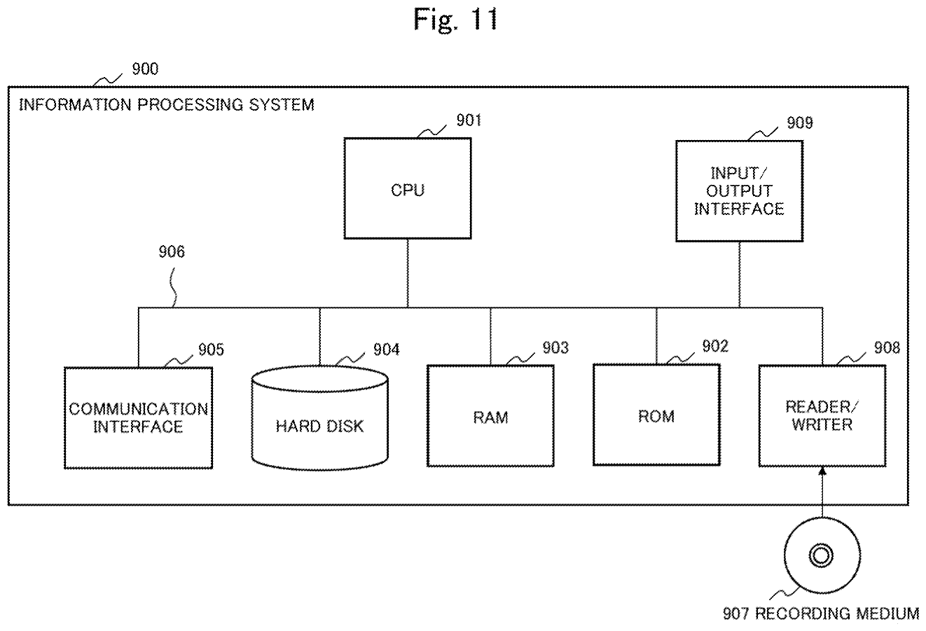

The acquisition unit 11 includes, for example, a communication circuit connected to one or a plurality of computer devices or a database that transmits the action history information 100 and the personal relationship information 103, and a storage device that stores information acquired by the communication circuit. The storage device may be a hard disk 904 or a RAM 903 of an information processing system 900 illustrated in FIG. 11 described later.

The action history information 100 is information indicating a time-series change (transition) in action of a person concerned in the case. The action history information 100 includes movement history information 101 and communication history information 102.

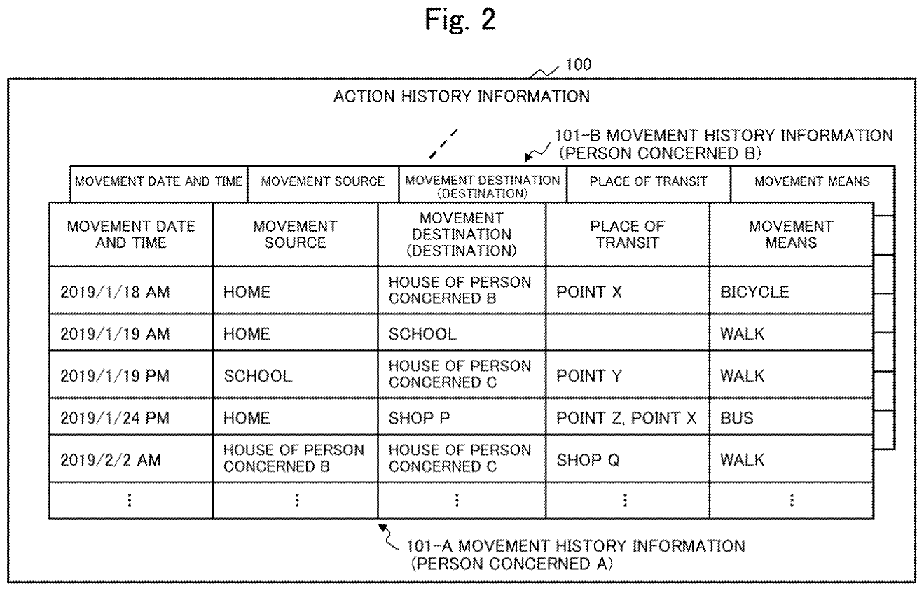

FIG. 2 is a diagram illustrating contents of data of the movement history information 101 according to the present example embodiment. The movement history information 101 represents a history in which a person concerned in the case has moved from one place to another. The movement history information 101 is, for example, information created by the user based on information obtained by an investigation activity such as an inquiry investigation by a police investigator. The movement history information 101 is created, for example, for each of the persons concerned and the movement history information 101-A and 101-B illustrated in FIG. 2 represent the histories in which a person concerned A and a person concerned B move, respectively, (that is, time-series change in movement).

The movement history information 101 includes a movement date and time, a place of a movement source, a place of a movement destination (destination), a place of transit in movement, and a movement means (walk, bicycle, automobile, railway, etc.). The movement history information 101 may include, for example, information other than the information (item) illustrated in FIG. 2, such as a name of a road through which the user has moved, and a route name and a station name of a used railway.

In the movement history information 101 exemplified in FIG. 2, a movement source, a movement destination, a place of transit, and the like each represent a place representing a position for the case or a place representing a position for living of a person concerned in the case. The place representing the position in the case is, for example, a case occurrence scene, a weapon discovery scene, a sighting scene, or the like. The place representing the position of the person concerned in the case in living is, for example, a home, a school, a place of employment, or the like. The movement history information 101 may include information indicating an attribute of each place. The attribute of each place is, for example, a situation of seeing a suspicious person or a suspicious object at the place. The situation of the suspicious person or the suspicious object being seen is, for example, “a speed limit violation vehicle has been seen”. Note that the movement history information illustrated in FIG. 2 is created for each person concerned in the case, but may be represented in a format in which the movement history information of the persons concerned in the case is integrated.

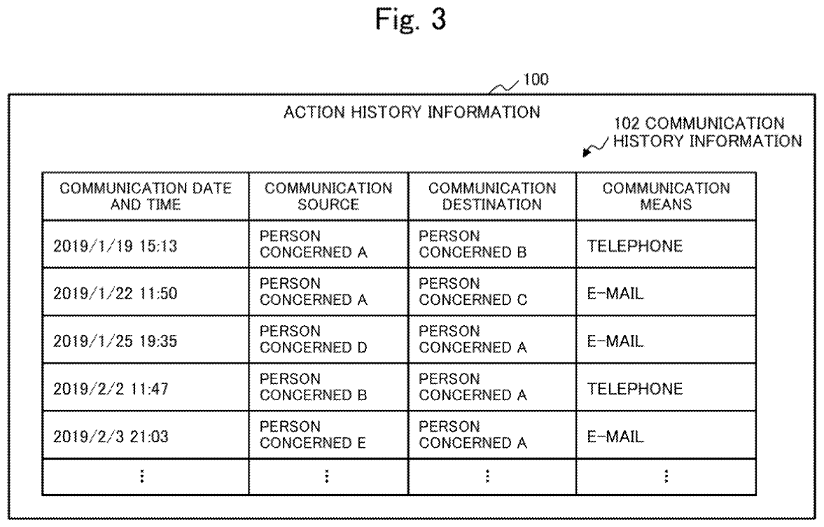

FIG. 3 is a diagram illustrating contents of data of the communication history information 102 according to the present example embodiment. The communication history information 102 indicates a history of communication performed by a certain person concerned with another person concerned (that is, a time-series change in communication). The communication history information 102 is, for example, information created by the user based on information obtained by an investigation activity by a police investigator, such as checking a communication history of a mobile phone of a person concerned. The communication history information 102 includes a communication date and time, a communication source person concerned, a communication destination person concerned, and a communication means. However, the communication history information 102 may include information other than the information illustrated in FIG. 3, such as a communication content. Note that, in the example of FIG. 3, the action history information is collected as one piece of information, but may be created separately for each person concerned.

The communication history information 102 may include information indicating an attribute of a person concerned. The attribute of the person concerned is, for example, an age, a sex, an occupation, a place of employment, a place of residence, and the like of the person concerned.

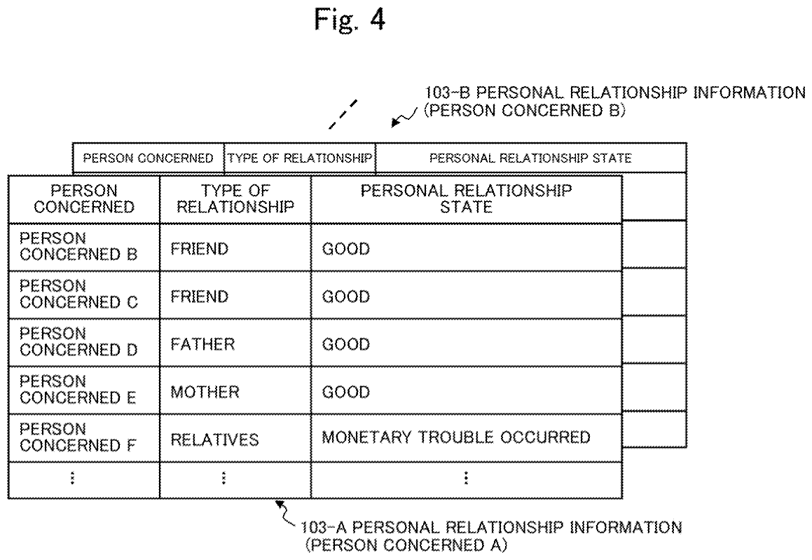

FIG. 4 is a diagram illustrating contents of data of the personal relationship information 103 according to the present example embodiment. The personal relationship information 103 indicates a personal relationship with another person concerned for each person concerned. The personal relationship information 103 is, for example, information created by the user based on information obtained by an investigation activity such as an inquiry investigation by a police investigator. The personal relationship information 103 is created, for example, for each person concerned, and the personal relationship information 103-A and 103-B illustrated in FIG. 4 represent personal relationships with another person concerned with respect to the person concerned A and the person concerned B, respectively.

The personal relationship information 103 includes a type of a relationship (family relationship, friend, colleague, business associate, boyfriend/girlfriend, former boyfriend/girlfriend, acquaintance only on social networking service (SNS), and the like) and a state of a personal relationship (good, no contact for a predetermined period, money trouble, etc.) with another person concerned. The type of the relationship and the state of the personal relationship in the personal relationship information 103 are dynamic information that changes in time series, such as occurrence or resolution of trouble. The personal relationship information 103 may include, for example, a degree of deterioration of a personal relationship. The degree of deterioration of the personal relationship is, for example, a state in which a personal relationship between certain persons concerned is bad but a case such as an injury has not yet occurred (presence or absence of trouble and contents of trouble), a state in which a case such as an injury or some trouble has already occurred between the persons concerned, and the like. Then, the tendency of the state of the personal relationship to change in time series is one of indices for estimating the type of the case. The personal relationship information 103 may include information other than the information illustrated in FIG. 4. The information other than the information illustrated in FIG. 4 is, for example, a relationship history (friend history, acquaintance history, time of first acquaintance, etc.) between the persons concerned, a change timing of a personal relationship such as “a trouble has occurred with the person concerned B on *** date, *** month, 20**, and the relationship has changed from good to bad”, a reason of the change, and a change content.

Acquisition unit 11 stores the movement history information 101, the communication history information 102, and the personal relationship information 103 acquired as described above in a storage device (for example, a memory, a hard disk, or the like) (not illustrated).

A graph generation unit 12 illustrated in FIG. 1 generates a graph 120 representing, for example, the movement history information 101, about a certain case to be learned, acquired by the acquisition unit 11 and a graph 120 representing the communication history information 102 and the personal relationship information 103. Specifically, graph generation unit 12 reads the movement history information 101, the communication history information 102, and the personal relationship information 103 from the storage device to generate the graph 120 based on the graph generation algorithm. The graph 120 representing the movement history information 101 represents a time-series change in movement of each person concerned in the case. The graph 120 representing the communication history information 102 and the graph 120 representing the personal relationship information 103 represent the time-series change in communication of the person concerned in the case and personal relationship of the person concerned.

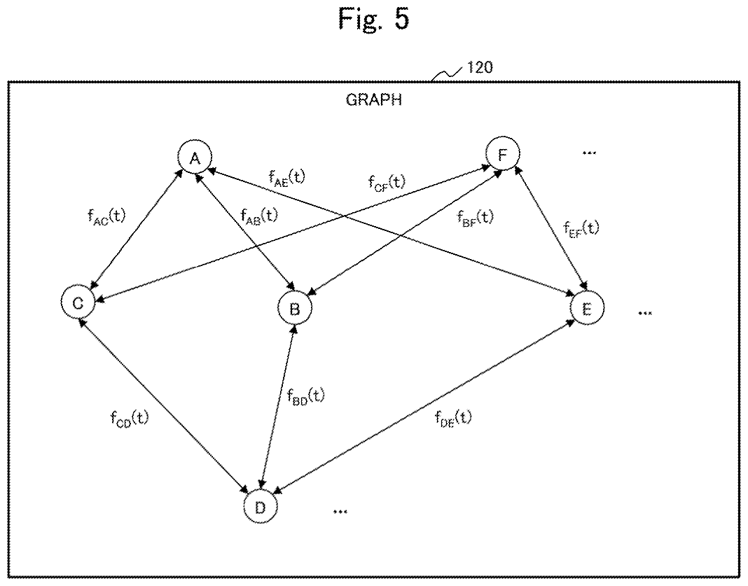

FIG. 5 is a diagram illustrating a configuration of the graph 120 according to the present example embodiment. As illustrated in FIG. 5, the graph 120 includes a node indicated by a circle surrounding the name of the element about the case and an edge connecting the nodes with an arrow. Note that the graph 120 is not limited to the configuration illustrated in FIG. 5, and for example, the edge may be represented by a line that does not indicate a direction instead of an arrow.

For example, in graph 120 representing the communication history information 102 and the personal relationship information 103, a node represents a person concerned (person concerned A, person concerned B, etc.), and an edge represents communication and a personal relationship between persons concerned. Each node in the graph 120 includes attribute information (age, sex, occupation, etc.) of a person concerned. The attribute information indicated by each node is stored in a storage device (for example, the hard disk 904 or the RAM 903) not illustrated.

In the graph 120 representing the communication history information 102 and the personal relationship information 103, for example, an edge connecting a node representing the person concerned A and a node representing the person concerned B represents communication between the person concerned A and the person concerned B represented by the communication history information 102, and is represented by a function f_{AB}(t) illustrated in FIG. 5, where t represents time. The personal relationship between the person concerned A and the person concerned B indicated by the personal relationship information 103 is also represented by the function f_{AB}(t) illustrated in FIG. 5.

As described above, the function such as the function f_{AB}(t) representing each edge is a multi-dimensional function having the time t as a variable and including the item (for example, a communication means) included in the communication history information 102 and the item (for example, a state of a personal relationship) included in the personal relationship information 103 as elements. The multi-dimensional function representing an edge is stored in a storage device (for example, the hard disk 904 or the RAM 903) not illustrated in association with the edge.

In the graph 120 representing the movement history information 101, a node represents a place (home of the person concerned, home of another person concerned, point X, etc.), and an edge represents at least one of a movement path and a movement means. Each node in the graph 120 includes place attribute information (a state of being seen by a suspicious person, or the like). The edge in the graph 120 representing the movement history information 101 is also represented by a multi-dimensional function having the time t as a variable, as in the graph 120 representing the communication history information 102 and the personal relationship information 103.

The graph generation unit 12 further assigns a label to a graph 120 for teacher data to be used when a model generation unit 13 to be described later performs machine learning, the graph being generated for a case to be learned. The graph generation unit 12 sets the type of the case that has already been resolved as the label.

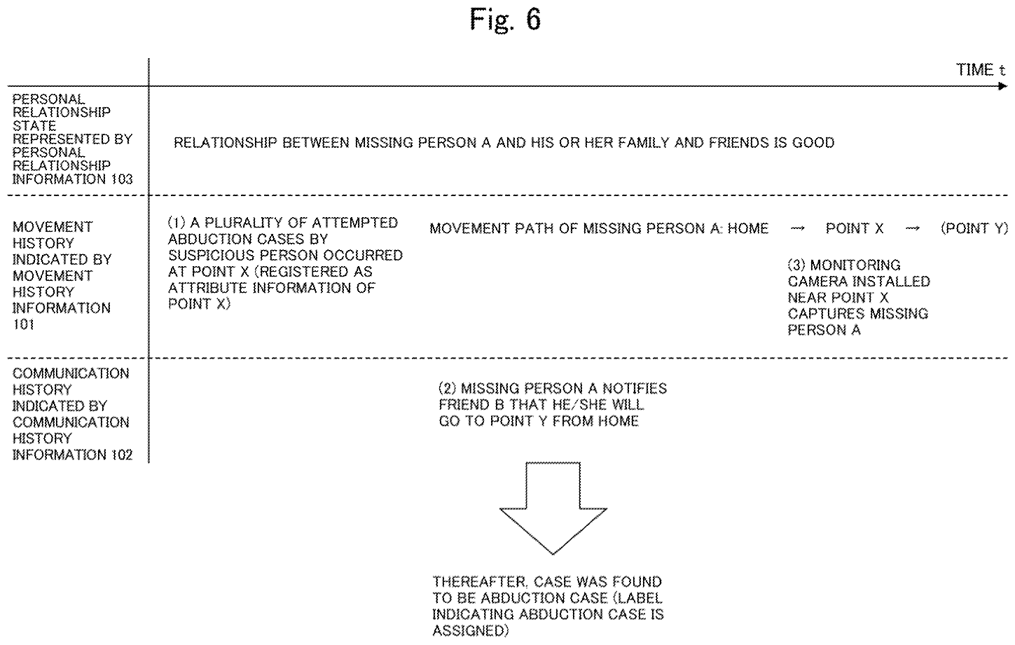

FIG. 6 is a diagram illustrating a procedure in which the graph generation unit 12 generates the graph 120 used as teacher data when the model generation unit 13 described later generates the estimation model 130. The movement history information 101 and the communication history information 102 exemplified in FIG. 6 indicate that the following events occur in chronological order in the missing case of a missing person A to be learned.

(1) A plurality of attempted abduction cases by a suspicious person occurred at a point X.
(2) The missing person A informed a friend B of going to a point Y from the home.
(3) A monitoring camera installed near the point X captured the missing person A.
The personal relationship information 103 indicates that the relationship between the missing person A and the person's family and friends was good before the occurrence of the case.

The graph generation unit 12 generates the graph 120 to be used as teacher data based on the movement history information 101 and the communication history information 102 indicating the event described above and the personal relationship information 103 indicating the personal relationship before the occurrence of the case.

Note that the graph generation unit 12 may generate (draw) a function graph instead of the graph structure data as described above. In this case, for example, the graph generation unit 12 may generate a graph (function) in which a horizontal axis represents time (date and time) and a vertical axis represents an index indicating an action of a person concerned.

It is assumed that the missing case exemplified in FIG. 6 was resolved after the missing person A disappears, and was found to be an abduction case. In this case, the graph generation unit 12 assigns a statement that the type of the case is an abduction case, as a label, to the graph 120 used as teacher data.

The graph generation unit 12 stores the configuration of the graph 120 labeled as described above in the storage device. The graph generation unit 12 outputs the labeled graph 120 to the model generation unit 13 as teacher data.

The model generation unit 13 generates the estimation model 130 (learned model) used when the estimation unit 14 to be described later estimates the type of the case using the labeled graph 120 input from the graph generation unit 12 as teacher data. The model generation unit 13 performs, by the processor, machine learning for generating the estimation model 130 (learned model) using the above-described teacher data.

Specifically, the model generation unit 13 extracts, from the input graph 120, features of time-series changes in action (movement, communication) of a person concerned, personal relationship of the person concerned, and attribute of each of a person concerned and a place, using a predetermined algorithm. The model generation unit 13 can use, for example, TGFN, STAR, Netwalk, or the like described above as the predetermined algorithm.

The model generation unit 13 extracts, from the graph 120, static features and dynamic features that change with time regarding an action of the person concerned, a personal relationship of a person concerned, and an attribute of each of a person concerned and a place by using, for example, TGFN. Alternatively, the model generation unit 13 extracts a node important (that is, the degree of influence on estimation is high) in estimation of the type of the case in each of the time axis (viewpoint over a certain period) and the spatial axis (viewpoint focusing on individual time) by using, for example, STAR. Alternatively, the model generation unit 13 extracts the feature amount of the node from the graph 120 by using, for example, Netwalk. When Netwalk is used, the model generation unit 13 may combine it with an existing prediction algorithm such as gradient boosting, for example.

Next, in the process of performing machine learning using the above-described teacher data, the model generation unit 13 determines an explanatory variable related to the type of the case from the result of extracting the feature from the graph 120 as described above. A specific example of the explanatory variable will be described later. Specifically, the result of extracting features from the graph 120 is a static feature and a dynamic feature, or a feature amount of a node regarding an action (movement, communication) of a person concerned, a personal relationship of the person concerned, and an attribute of each of the person concerned and the place. Then, the model generation unit 13 generates the estimation model 130 including a reference for estimating the type of the case based on the explanatory variable determined from the result of extracting the feature. The model generation unit 13 determines the reference by performing machine learning on the relationship between the explanatory variable in the teacher data and the label assigned by the graph generation unit 12.

The model generation unit 13 determines, for example, a first explanatory variable related to the time-series change in action of the person concerned indicated by the action history information 100. The first explanatory variable represents, but is not limited to, a movement source and a movement destination, a movement path, a movement means, a communication source and a communication destination in communication, a communication means, and the like regarding a person concerned. For example, the model generation unit 13 determines a second explanatory variable related to the time-series change in personal relationship between the persons concerned indicated by the personal relationship information 103. The second explanatory variable indicates, for example, a situation of occurrence or resolution of a trouble between the persons concerned, but is not limited thereto.

When determining the explanatory variable as described above, the model generation unit 13 also determines a degree of importance in estimation of the type of the case (contribution to the estimation result) for each of the plurality of explanatory variables. In the reference for estimating the type of the case described above, the model generation unit 13 may weight the value representing each explanatory variable by the degree of importance of the explanatory variable. At this time, the model generation unit 13 may determine different degree of importance for each of the persons concerned or places from a difference in features related to the action history information 100 and the personal relationship information 103 between the persons concerned or places for the same explanatory variable. That is, for example, the model generation unit 13 may set the degree of importance to be high when a certain explanatory variable relates to the person concerned A or the place X, and may set the degree of importance to be low when a certain explanatory variable relates to the person concerned B or the place Y.

The model generation unit 13 stores the estimation model 130 generated or updated as described above in a non-volatile storage device (not illustrated). The model generation unit 13 can gradually improve the estimation accuracy by updating (also referred to as relearning) the estimation model 130, for example, every predetermined time.

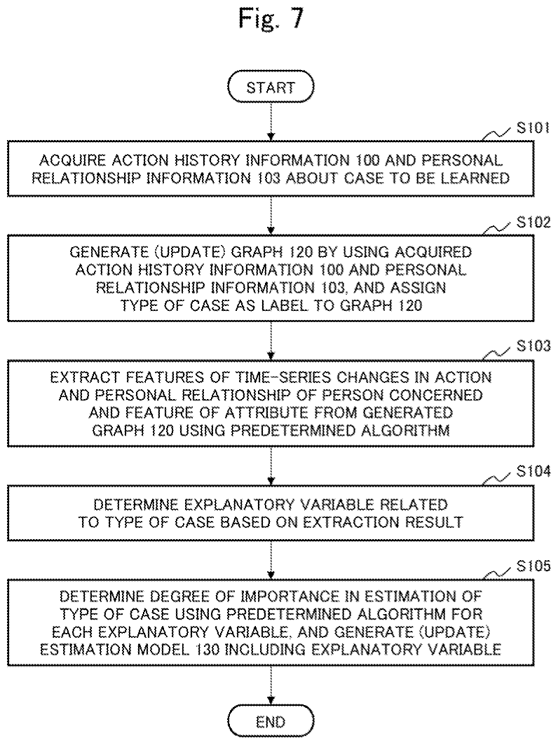

Next, an operation (processing) in which the crime investigation assisting system 10 according to the present example embodiment generates the estimation model 130 (performs machine learning) will be described in detail with reference to a flowchart of FIG. 7.

The acquisition unit 11 acquires the action history information 100 and the personal relationship information 103 about the case to be learned, which are used as teacher data, from the outside (step S101). The graph generation unit 12 generates (updates) the graph 120 by using the action history information 100 and the personal relationship information 103 acquired by the acquisition unit 11, and assigns the type of the case as a label to the graph 120 (step S102).

The model generation unit 13 extracts, from the graph 120 generated by the graph generation unit 12, features of time-series changes in action and personal relationship and a feature of an attribute of a person concerned using a predetermined algorithm (step S103). The model generation unit 13 determines an explanatory variable related to the type of the case based on the extraction result (step S104).

The model generation unit 13 determines the degree of importance in estimation of the type of the case using a predetermined algorithm for each explanatory variable, and generates (updates) the estimation model 130 including the explanatory variable to which the degree of importance has been assigned (step S105), and the entire process ends.

<Operation of Estimating Type of Case Under Investigation >

Next, an operation in which the crime investigation assisting system 10 according to the present example embodiment estimates the type of the case under investigation using the generated or updated estimation model 130 will be described.

The acquisition unit 11 acquires the action history information 100 and the personal relationship information 103 from an external device (not illustrated), as in the case where the crime investigation assisting system 10 generates the estimation model 130. However, the acquisition unit 11 acquires these pieces of information not as the above-described teacher data but as data to be estimated regarding the type of the case.

For example, as described above, it is assumed that the estimation model 130 is generated based on the action history information 100 and the personal relationship information 103 regarding an already resolved case (also referred to as a first case). In this case, the acquisition unit 11 acquires the action history information 100 and the personal relationship information 103 regarding the case under investigation (also referred to as a second case) to be estimated in accordance with an instruction input by the user via the management terminal device 20, for example. Modes of the action history information 100 and the personal relationship information 103 about the case under investigation are similar to those of the action history information 100 and the personal relationship information 103, respectively, used to generate the estimation model 130 illustrated in FIGS. 2 to 4.

The graph generation unit 12 generates the graph 120 representing the action history information 100 and the personal relationship information 103 about the case under investigation. Note that the configuration of the graph 120 is as described above with reference to FIG. 5.

The estimation unit 14 illustrated in FIG. 1 estimates the type of the case under investigation based on the graph 120 about the case under investigation and the estimation model 130.

As in the case where the model generation unit 13 generates or updates the estimation model 130, the estimation unit 14 extracts the features of the time-series change in action and personal relationship of the person concerned from the graph 120 input from the graph generation unit 12. At this time, the estimation unit 14 may use a predetermined algorithm such as TGFN, STAR, or Netwalk described above, for example.

The estimation unit 14 obtains the value of the explanatory variable defined by the estimation model 130 in the graph 120 based on the feature extracted from the graph 120. The estimation unit 14 estimates the type of the case under investigation by collating the obtained value of the explanatory variable with the reference for estimating the type of the case included in the estimation model 130.

The estimation unit 14 may also output a plurality of types as the result of estimation of the types of the cases. In the process of estimating the type of the case under investigation, the estimation unit 14 calculates a score (similarity) indicating similarity between the case under investigation and the case for each type serving as teacher data based on the value of the explanatory variable. Then, the estimation unit 14 outputs the types of cases from the type of the case having the highest score to the type of the case having the n-th highest score (n is an any natural number) as the estimation result.

The estimation unit 14 outputs a result of estimating the type of the case under investigation and information indicating the reason for the estimation to the display control unit 15. The information indicating the estimation reason is, for example, the value of the explanatory variable in the graph 120 for which the type of the case is to be estimated, the degree of importance of the explanatory variable, and the like.

The display control unit 15 displays, on the display screen 200 in the management terminal device 20, the result of estimating the type of the case under investigation and the information indicating the reason for the estimation both of which are input from the estimation unit 14. That is, the display control unit 15 causes the management terminal device 20 to display the estimation result and the estimation reason by the estimation unit 14 on the display screen 200 of the management terminal device 20.

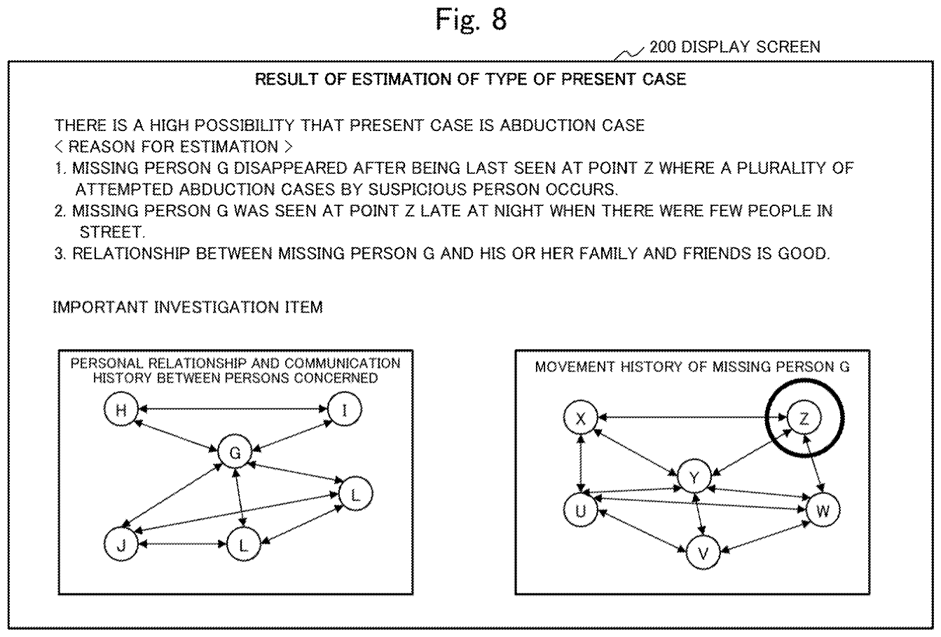

FIG. 8 is a diagram illustrating a mode in which the display control unit 15 according to the present example embodiment displays a result of estimating the type of the case under investigation and information indicating the reason for the estimation on the display screen 200.

The display screen 200 illustrated in FIG. 8 indicates that the present case (case under investigation) is highly likely to be an abduction case. Then, the display screen 200 indicates the reason why the case under investigation is highly likely to be an abduction case as follows in descending order of the degree of importance (contribution) of the explanatory variable.

1. The missing person G disappears after being last seen at a point Z where a plurality of attempted abduction cases by a suspicious person occurs.
(The estimation reason in this is that “the place where the case under investigation has occurred matches the place where there is a record of occurrence of the crime in the past”. That is, in this, the relationship between the occurrence of the case at the place where there is the record of occurrence of the crime and the type of the case is the estimation reason.)
2. The missing person G was seen at the point Z late at night when there were few people in the street.
(The estimation reason in this is that “the place where the case under investigation has occurred is in a specific time zone”. That is, in this, the relationship between the time zone in which the case occurred and the type of the case is the estimation reason.)
3. The relationship between the missing person G and the person's family and friends is good.
(The estimation reason in this is “the state of the personal relationship between the victim of the case and the person concerned”. That is, in this, the relationship between the state of the personal relationship between the victim and the person concerned and the type of the case is the estimation reason.)
The crime investigation assisting system 10 visibly presents the explanatory variable as the estimation reason to the administrator, thereby achieving an effect of improving the explanatory property. The crime investigation assisting system 10 can also visibly present the relationship between the explanatory variables contributing to the estimation as the reason for the estimation of the type of the case. At this time, the crime investigation assisting system 10 may visibly present the estimation reason in a form that is not a natural language sentence as long as the estimation reason is visually recognizable.

Although not illustrated in FIG. 8, for example, the display control unit 15 may display, on the display screen 200, the estimation reason that “the missing person went to the place where the case occurred upon receiving contact from a person with whom the missing person is acquainted via an SNS”. The estimation reason is that “after receiving an instruction from a person with whom is acquainted on the Internet, move to the place where the case occurred”. That is, in this case, the crime investigation assisting system 10 presents the feature (time-series feature) of the manner of time-series change of the movement history information 101 and the communication history information 102 as the estimation reason. The crime investigation assisting system 10 can further improve the explanatory property of the estimation result by presenting the time-series change (change timing or the like) of the explanatory variable in this manner.

Note that, as described above, in a case where the estimation unit 14 outputs a plurality of types as the result of estimation of the type of the case, the display control unit 15 causes the management terminal device 20 to display the plurality of types on the display screen 200 in order from the type of the case having the highest similarity to the case under investigation. At this time, the display control unit 15 may cause the management terminal device 20 to display a score indicating similarity on the display screen 200.

The display screen 200 illustrated in FIG. 8 displays a graph 120 representing a personal relationship and a communication history between the persons concerned and a graph 120 representing a movement history in order to indicate the important investigation item. Then, the display screen 200 exemplified in FIG. 8 indicates that the point Z is the important investigation item by surrounding the point Z in the graph 120 indicating the movement history with a thick circle. The point Z is a place related to an explanatory variable having a high degree of importance. The point Z, which is the important investigation item, is a target for which the search for belongings of the missing person G, a suspicious object, and the like by the police investigator is intensively performed.

In the example illustrated in FIG. 8, the crime investigation assisting system 10 sets, as explanatory variables, the attribute of the place where the missing person was last seen, the time when the missing person was last seen, and the state of the personal relationship between the missing person and other persons concerned. Then, the display control unit 15 displays the estimation reason including the name of the explanatory variable and its value on the display screen 200.

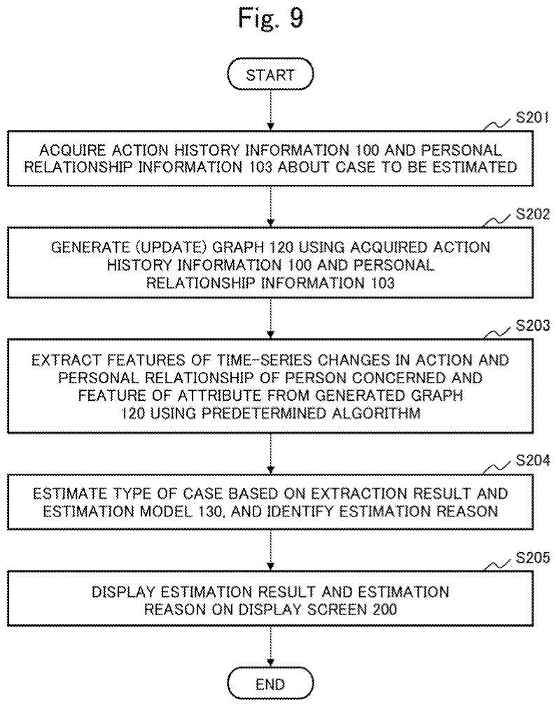

Next, with reference to a flowchart of FIG. 9, an operation (processing) of estimating a type of a case under investigation by the crime investigation assisting system 10 according to the present example embodiment will be described in detail.

The acquisition unit 11 acquires the action history information 100 and the personal relationship information 103 about the case under investigation that is to be estimated and is under investigation from the outside (step S201). The graph generation unit 12 generates (updates) the graph 120 by using the action history information 100 and the personal relationship information 103 acquired by the acquisition unit 11 (step S202).

The estimation unit 14 extracts, from the graph 120 generated by the graph generation unit 12, features of time-series changes in action and personal relationship and a feature of an attribute of a person concerned using a predetermined algorithm (step S203).

The estimation unit 14 estimates the type of the case under investigation based on the feature extraction result from the graph 120 and the estimation model 130, and identifies the reason for the estimation (step S204). The display control unit 15 displays the result of estimation of the type of the case under investigation by the estimation unit 14 and the reason for the estimation on the display screen 200 of the management terminal device 20 (step S205), and the entire process ends.

The crime investigation assisting system 10 according to the present example embodiment can suitably assist an investigation in such a way that a criminal case can be resolved even by a non-skilled police investigator. The reason is that the crime investigation assisting system 10 estimates the type of the case to be estimated based on the estimation model 130 generated using the result of extracting the feature of the time-series change from the information about the action history and the personal relationship of the person concerned in the resolved case.

Hereinafter, effects achieved by the crime investigation assisting system 10 according to the present example embodiment will be described in detail.

Usually, an investigation after occurrence of a criminal case is manually performed by a police investigator. Specifically, an investigation is often performed by relying on experience and intuition of a skilled police investigator. Therefore, a technology for suitably assisting the investigation of a criminal case in such a way that the case can be resolved without depending on experience and intuition of a skilled police investigator is expected.

One of methods for suitably assisting the investigation of a criminal case may include estimating the type of the case under investigation. Then, in order to estimate the type of the case under investigation with high accuracy, it is necessary to estimate the type based on various factors that complicatedly affect each other. Such factors include, for example, a feature of a time-series change (transition) in action of a person concerned in the case, a feature of a time-series change in personal relationship between persons concerned, and the like. Therefore, in order to estimate the type of the case with high accuracy, it is required to analyze the features of the time-series change in action and personal relationship of the persons concerned with high accuracy.

In order to achieve such an object, the crime investigation assisting system 10 according to the present example embodiment includes the estimation model 130 and the estimation unit 14, and operates as described above with reference to FIGS. 1 to 9, for example. That is, the estimation model 130 is a learned model representing a relationship between the action history information 100 and the personal relationship information 103 about the first case and the type of the first case. The estimation unit 14 estimates the type of the second case based on the action history information 100 and the personal relationship information 103 about the second case. The action history information 100 and the personal relationship information 103 are information indicating a time-series change in action and personal relationship of a person concerned in the first case or the second case.

The crime investigation assisting system 10 according to the present example embodiment generates the graph 120 that represents the action history information 100 and the personal relationship information 103, that includes nodes and edges, and that has a structure changing in time series. Then, the crime investigation assisting system 10 uses the above-described algorithms such as TGFN, STAR, and Netwalk capable of extracting and analyzing the features of the generated graph 120, thereby achieving grasping the features of the time-series change in action and personal relationship of the person concerned with high accuracy. As a result, the crime investigation assisting system 10 can suitably assist the investigation in such a way that the criminal case can be resolved even by a non-skilled police investigator.

In the process of generating the estimation model 130, the crime investigation assisting system 10 according to the present example embodiment determines explanatory variables regarding estimation of the type of case, and further determines the degree of importance (contribution degree) in estimation of the relationship between the types of cases for each explanatory variable. Then, the crime investigation assisting system 10 weights the explanatory variable by its degree of importance to estimate the type of the case. As a result, the crime investigation assisting system 10 performs estimation in which the features of the action history and the personal relationship of the person concerned in the case are captured accurately as compared with, for example, a case where estimation is performed without calculating the degree of importance, in such a way that the accuracy of estimating the type of the case can be improved.

In a general system that estimates an event using a learned model, an estimation process is a black box, and only an estimation result is presented without presenting an estimation reason. Therefore, it is difficult for a user to grasp the basis of the estimation result output by the system. On the other hand, the crime investigation assisting system 10 according to the present example embodiment displays the estimation reason of the type of the case based on the value of the explanatory variable on the display screen 200 of the management terminal device 20, for example, as illustrated in FIG. 8. As a result, the crime investigation assisting system 10 can improve the explanatory property related to the estimation reason of the type of the case.

The crime investigation assisting system 10 according to the present example embodiment displays a person concerned and a place related to an explanatory variable having a high degree of importance as an important investigation item in a mode exemplified in FIG. 8, for example. As a result, the crime investigation assisting system 10 can present an appropriate investigation leading to quick resolution of the case to the police investigator.

In the present example embodiment described above, an example of classifying the type of the case using the estimation model generated by the supervised machine learning is described. However, the crime investigation assisting system 10 can also classify the type of the case by a clustering method that is unsupervised machine learning.

### Second Example Embodiment

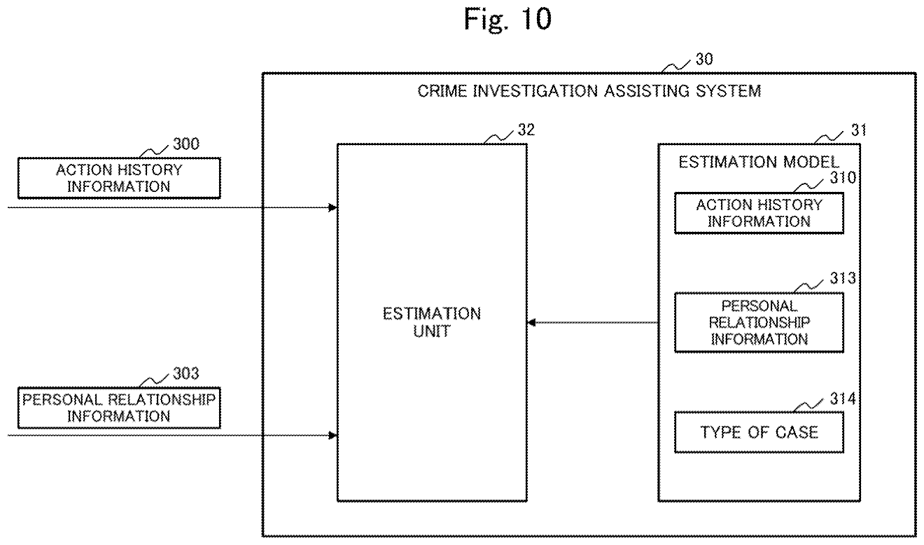

FIG. 10 is a block diagram illustrating a configuration of a crime investigation assisting system 30 according to a second example embodiment of the present invention. The crime investigation assisting system 30 includes an estimation unit 32 that uses an estimation model 31. The estimation unit 32 is an example of an estimation means.

The estimation model 31 represents a relationship between action history information 310 and personal relationship information 313 regarding the first case (resolved case on which machine learning is performed) and the type 314 of the first case. As in the estimation model 130 according to the first example embodiment, for example, the estimation model 31 is a learned model representing a result of performing machine learning on a relationship between the action history information 310 and the personal relationship information 313, and the type 314 of the first case.

The action history information 310 represents a time-series change in action of a person concerned in the first case. The action history information 310 may be, for example, information similar to the action history information 100 described with reference to FIGS. 2 to 4 with respect to the first example embodiment.

The personal relationship information 313 represents a time-series change in personal relationship of a person concerned in the first case, and may be, for example, information similar to the personal relationship information 103 described with reference to FIG. 4 with respect to the first example embodiment.

The estimation unit 32 estimates the type of the second case based on action history information 300 and personal relationship information 303 related to the second case (case under investigation that is to be estimated) and the estimation model 31.

When estimating the type of the case, the estimation unit 32 extracts features of time-series changes in action and personal relationship of a person concerned in the case from the action history information 300 and the personal relationship information 303, as in the estimation unit 14 according to the first example embodiment. At this time, the estimation unit 32 can use the predetermined algorithm (TGFN, STAR, Netwalk, etc.) described in the first example embodiment.

The crime investigation assisting system 30 according to the present example embodiment can suitably assist an investigation in such a way that a criminal case can be resolved even by a non-skilled police investigator. The reason is that the crime investigation assisting system 30 estimates the type of the case to be estimated based on the estimation model 31 generated using the result of extracting the feature of the time-series change from the information about the action history and the personal relationship of the person concerned in the resolved case.

<Hardware Configuration Example>

Each unit of the crime investigation assisting system 10 illustrated in FIG. 1 or the crime investigation assisting system 30 illustrated in FIG. 10 in each of the above-described example embodiments can be achieved by dedicated hardware (HW) (electronic circuit). In FIGS. 1 and 10, at least the following configuration can be regarded as a function (processing) unit (software module) of a software program.
Acquisition unit 11
Graph generation unit 12
Model generation unit 13
Estimation units 14 and 32
Display control unit 15

However, the division of each unit illustrated in these drawings is a configuration for convenience of description, and various configurations can be assumed at the time of implementation. An example of a hardware environment in this case will be described with reference to FIG. 11.

FIG. 11 is a diagram exemplarily illustrating a configuration of the information processing system 900 (computer system) capable of achieving the crime investigation assisting system 10 according to the first example embodiment or the crime investigation assisting system 30 according to the second example embodiment of the present invention. That is, FIG. 11 is a configuration of at least one computer (information processing apparatus) capable of achieving the crime investigation assisting systems 10 and 30 illustrated in FIGS. 1 and 10, and represents a hardware environment capable of achieving each function in the above-described example embodiment.

The information processing system 900 illustrated in FIG. 11 includes the following units as components, but may not include some of the following units.
CPU (Central_Processing Unit) 901
ROM (Read_Only_Memory) 902
RAM (Random_Access_Memory) 903
Hard disk (storage device) 904
Communication interface 905 with an external device
Bus 906 (communication line)
Reader/writer 908 capable of reading and writing data stored in a recording medium 907 such as a CD-ROM
(Compact_Disc_Read_Only_Memory)

Input/output interface 909 such as a monitor, a speaker, or a keyboard

That is, the information processing system 900 including the above-described components is a general computer to which these components are connected via the bus 906. The information processing system 900 may include a plurality of CPUs 901 or may include a CPU 901 configured by a plurality of cores. The information processing system 900 may include a GPU (Graphical_Processing_Unit) (not illustrated) in addition to the CPU 901.

Then, the present invention described using the above-described example embodiment as an example supplies a computer program capable of achieving the following functions to the information processing system 900 illustrated in FIG. 11. The function is the above-described configuration in the block configuration diagram (FIGS. 1 and 10) referred to in the description of the example embodiment or the function of the flowchart (FIGS. 7 and 9). Thereafter, the present invention is achieved by reading, interpreting, and executing the computer program on the CPU 901 of the hardware. The computer program supplied into the device may be stored in a readable/writable volatile memory (RAM 903) or a non-volatile storage device such as the ROM 902 or the hard disk 904.

In the above case, a general procedure can be used at present as a method of supplying the computer program into the hardware. Examples of the procedure include a method of installing the program in the apparatus via various recording media 907 such as a CD-ROM, a method of downloading the program from the outside via a communication line such as the Internet, and the like. In such a case, the present invention can be understood to be constituted by a code constituting the computer program or the recording medium 907 storing the code.

The present invention is described above using the above-described example embodiments as exemplary examples. However, the present invention is not limited to the above-described example embodiments. That is, the present invention can have various aspects that can be understood by those skilled in the art within the scope of the present invention.

Note that part or all of each of the above-described example embodiments can also be described as the following Supplementary note. However, the present invention exemplarily described by the above-described example embodiments is not limited to the following.

(Supplementary Note 1)

A crime investigation assisting system including
an estimation means configured to estimate, based on an estimation model representing a relationship between action history information and personal relationship information about a first case and a type of the first case, and the action history information and the personal relationship information about a second case, a type of the second case, wherein
the action history information represents a time-series change in action of a person concerned in the first case or the second case, and
the personal relationship information represents a time-series change in personal relationship of the person concerned in the first case or the second case.

(Supplementary Note 2)

The crime investigation assisting system according to Supplementary note 1, further including
a display control means configured to control a display device to display an estimation reason of the type of the second case.

(Supplementary Note 3)

The crime investigation assisting system according to Supplementary note 2, wherein
the action history information represents a history of movement of the person concerned.

(Supplementary note 4)

The crime investigation assisting system according to Supplementary note 2 or 3, wherein
the action history information represents a history of communication performed between a plurality of the persons concerned.

(Supplementary note 5)

The crime investigation assisting system according to Supplementary note 4, wherein
the action history information represents a position where the person concerned has performed communication by operating a terminal device.

(Supplementary note 6)

The crime investigation assisting system according to any one of Supplementary notes 2 to 5, wherein
the personal relationship information represents at least one of a type of a personal relationship between the persons concerned and an occurrence situation of a problem between the persons concerned.

(Supplementary note 7)

The crime investigation assisting system according to any one of Supplementary notes 2 to 6, further including
a graph generation means configured to generate a graph representing the action history information and the personal relationship information.

(Supplementary note 8)

The crime investigation assisting system according to Supplementary note 7, wherein
the graph includes, for each of the persons concerned, a node representing a movement source or a movement destination when the person concerned moves, and an edge representing a movement path from the movement source to the movement destination.

(Supplementary note 9)

The crime investigation assisting system according to Supplementary note 7, wherein
the graph includes a node representing the person concerned and an edge representing a communication performed between the persons concerned.

(Supplementary note 10)

The crime investigation assisting system according to Supplementary note 7, wherein
the graph includes a node representing the person concerned, and an edge representing at least one of a type of a personal relationship between the persons concerned and an occurrence situation of a problem between the persons concerned.

(Supplementary note 11)

The crime investigation assisting system according to any one of Supplementary notes 7 to 10, further including
a model generation means configured to generate the estimation model based on the action history information and the personal relationship information about the first case and a type of the first case found after a resolution of the first case.

(Supplementary note 12)

The crime investigation assisting system according to Supplementary note 11, wherein
the model generation means extracts a feature of a time-series change in action and personal relationship of the person concerned in the first case from the graph to which a type of the first case found after a resolution of the first case is assigned as a label by using a predetermined algorithm, and then determines an explanatory variable related to a type of the first case based on a result of the extraction, thereby generating the estimation model including the explanatory variable.

(Supplementary note 13)

The crime investigation assisting system according to Supplementary note 12, wherein
the model generation means determines a degree of importance in estimation of a type of the first case for each of a plurality of the explanatory variables, and
the estimation means estimates a type of the second case based on the degree of importance.

(Supplementary note 14)

The crime investigation assisting system according to Supplementary note 13, wherein
the model generation means determines the degree of importance different for each of the persons concerned in the first case with respect to the same explanatory variable.

(Supplementary note 15)

The crime investigation assisting system according to Supplementary note 13 or 14, wherein
the display control means controls the display device to display names of the explanatory variables side by side in descending order of the degree of importance and display the estimation reason in a mode of displaying values of the explanatory variables.

(Supplementary note 16)

The crime investigation assisting system according to any one of Supplementary notes 13 to 15, wherein
the display control means controls the display device to display the person concerned and a place, as an important investigation item, related to the explanatory variable having the high degree of importance in the second case.

(Supplementary note 17)

The crime investigation assisting system according to any one of Supplementary notes 1 to 16, wherein the estimation means calculates similarity between the first case and the second case based on an estimation model representing a relationship between action history information and personal relationship information about the first case and a type of the first case, and the action history information and the personal relationship information about the second case, and estimates a type of the second case based on the similarity.

(Supplementary note 18)

The crime investigation assisting system according to any one of Supplementary notes 1 to 17, wherein
the estimation means calculates, based on an estimation model representing a relationship between action history information and personal relationship information about a plurality of the first cases and types of a plurality of the first cases, and the action history information and the personal relationship information about the second case, similarity between each of the plurality of first cases and the second case, and
the display control means displays case types in descending order of the similarity.

(Supplementary note 19)

A crime investigation assisting device including
an estimation means configured to estimate, based on an estimation model representing a relationship between action history information and personal relationship information about a first case and a type of the first case, and the action history information and the personal relationship information about a second case, a type of the second case, wherein
the action history information represents a time-series change in action of a person concerned in the first case or the second case, and
the personal relationship information represents a time-series change in personal relationship of the person concerned in the first case or the second case.

(Supplementary note 20)

A crime investigation assisting method including by an information processing system,
estimating, based on an estimation model representing a relationship between action history information and personal relationship information about a first case and a type of the first case, and the action history information and the personal relationship information about a second case, a type of the second case, wherein
the action history information represents a time-series change in action of a person concerned in the first case or the second case, and
the personal relationship information represents a time-series change in personal relationship of the person concerned in the first case or the second case.

(Supplementary note 21)

A recording medium storing a crime investigation assisting program for causing a computer to execute an estimation process of estimating, based on an estimation model representing a relationship between action history information and personal relationship information about a first case and a type of the first case, and the action history information and the personal relationship information about a second case, a type of the second case, wherein
the action history information represents a time-series change in action of a person concerned in the first case or the second case, and
the personal relationship information represents a time-series change in personal relationship of the person concerned in the first case or the second case.

### REFERENCE SIGNS LIST

10 crime investigation assisting system

100 action history information

101 movement history information

102 communication history information

103 personal relationship information

11 acquisition unit

12 graph generation unit

120 graph

13 model generation unit

130 estimation model

14 estimation unit

15 display control unit

20 management terminal device

200 display screen

30 crime investigation assisting system

300 action history information

303 personal relationship information

31 estimation model

310 action history information

313 personal relationship information

314 type of case

32 estimation unit

900 information processing system

901 CPU

902 ROM

903 RAM

904 hard disk (storage device)

905 communication interface

906 bus

907 recording medium

908 reader/writer

909 Input/output interface

What is claimed is:

1. A crime investigation assisting system comprising:
a memory storing instructions; and
one or more processors configured to execute the instructions to:
estimate, based on an estimation model representing a relationship between action history information and personal relationship information about a first case and a type of the first case, and the action history information and the personal relationship information about a second case, a type of the second case, wherein
the action history information represents a time-series change in action of a person concerned in the first case or the second case, and
the personal relationship information represents a time-series change in personal relationship of the person concerned in the first case or the second case.

2. The crime investigation assisting system according to claim 1, wherein the one or more processors are further configured to execute the instructions to:
control a display device to display an estimation reason of the type of the second case.

3. The crime investigation assisting system according to claim 2, wherein
the action history information represents a history of movement of the person concerned.

4. The crime investigation assisting system according to claim 2, wherein
the action history information represents a history of communication performed between a plurality of the persons concerned.

5. The crime investigation assisting system according to claim 4, wherein
the action history information represents a position where the person concerned has performed communication by operating a terminal device.

6. The crime investigation assisting system according to claim 2, wherein
the personal relationship information represents at least one of a type of a personal relationship between the persons concerned and an occurrence situation of a problem between the persons concerned.

7. The crime investigation assisting system according to claim 2, wherein the one or more processors are further configured to execute the instructions to:
generate a graph representing the action history information and the personal relationship information.

8. The crime investigation assisting system according to claim 7, wherein
the graph includes, for each of the persons concerned, a node representing a movement source or a movement destination when the person concerned moves, and an edge representing a movement path from the movement source to the movement destination.

9. The crime investigation assisting system according to claim 7, wherein
the graph includes a node representing the person concerned and an edge representing a communication performed between the persons concerned.

10. The crime investigation assisting system according to claim 7, wherein
the graph includes a node representing the person concerned, and an edge representing at least one of a type of a personal relationship between the persons concerned and an occurrence situation of a problem between the persons concerned.

11. The crime investigation assisting system according to claim 7, wherein the one or more processors are further configured to execute the instructions to:
generate the estimation model based on the action history information and the personal relationship information about the first case and a type of the first case found after a resolution of the first case.

12. The crime investigation assisting system according to claim 11, wherein the one or more processors are further configured to execute the instructions to:
extract a feature of a time-series change in action and personal relationship of the person concerned in the first case from the graph to which a type of the first case found after a resolution of the first case is assigned as a label by using a predetermined algorithm, and then determines an explanatory variable related to a type of the first case based on a result of the extraction, thereby generating the estimation model including the explanatory variable.

13. The crime investigation assisting system according to claim 12, wherein the one or more processors are further configured to execute the instructions to:
determine a degree of importance in estimation of a type of the first case for each of a plurality of the explanatory variables, and
estimate a type of the second case based on the degree of importance.

14. The crime investigation assisting system according to claim 13, wherein the one or more processors are further configured to execute the instructions to:
determine the degree of importance different for each of the persons concerned in the first case with respect to the same explanatory variable.

15. The crime investigation assisting system according to claim 13, wherein the one or more processors are further configured to execute the instructions to:
control the display device to display names of the explanatory variables side by side in descending order of the degree of importance and display the estimation reason in a mode of displaying values of the explanatory variables.

16. The crime investigation assisting system according to claim 13, wherein the one or more processors are further configured to execute the instructions to:
control the display device to display the person concerned and a place, as an important investigation item, related to the explanatory variable having the high degree of importance in the second case.

17. The crime investigation assisting system according to claim 1, wherein the one or more processors are further configured to execute the instructions to:
calculate similarity between the first case and the second case based on an estimation model representing a relationship between action history information and personal relationship information about the first case and a type of the first case, and the action history information and the personal relationship information about the second case, and
estimate a type of the second case based on the similarity.

18. The crime investigation assisting system according to claim 1, wherein the one or more processors are further configured to execute the instructions to:
calculate, based on an estimation model representing a relationship between action history information and personal relationship information about a plurality of the first cases and types of a plurality of the first cases, and the action history information and the personal relationship information about the second case, similarity between each of the plurality of first cases and the second case, and
display case types in descending order of the similarity.

19. (canceled)

20. A crime investigation assisting method comprising:
by an information processing system,
estimating, based on an estimation model representing a relationship between action history information and personal relationship information about a first case and a type of the first case, and the action history information and the personal relationship information about a second case, a type of the second case, wherein
the action history information represents a time-series change in action of a person concerned in the first case or the second case, and
the personal relationship information represents a time-series change in personal relationship of the person concerned in the first case or the second case.

21. A non-transitory computer-readable recording medium storing a crime investigation assisting program for causing a computer to execute:
an estimation process of estimating, based on an estimation model representing a relationship between action history information and personal relationship information about a first case and a type of the first case, and the action history information and the personal relationship information about a second case, a type of the second case, wherein
the action history information represents a time-series change in action of a person concerned in the first case or the second case, and
the personal relationship information represents a time-series change in personal relationship of the person concerned in the first case or the second case.
